(19) United States
(12) Patent Application Publication
(10) Pub. No.: US 2005/0114682 A1
(43) Pub. Date: May 26, 2005

(54) Methods and apparatus for securely configuring a machine in a pre-operating system environment

(76) Inventors: Vincent J. Zimmer, Federal Way, WA (US); Michael A. Rothman, Gig Harbor, WA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/723,011

(22) Filed: Nov. 26, 2003

(51) Int. Cl. H04L 9/32; G06F 11/30; G06F 12/14

(52) U.S. Cl. 713/187

(57) ABSTRACT

Methods and apparatus for securely configuring a machine in a pre-operating system environment are disclosed. A server determines if configuration updates are available to be transmitted to various clients that are enabled to receive configuration updates in a pre-operating system environment. The server broadcasts a message indicating the availability of a configuration update and requests an attestation from each of the responding clients. The attestation may be a conventional attestation if the client is a managed client or the attestation may be a pseudo-anonymous attestation if the client is an independent client. The server verifies the authenticity of the attestation by querying a Trusted Third Party and transmits the configuration update after the client's identity has been verified. The client receives the configuration update, applies the update, and then continues its booting process.

### TECHNICAL FIELD

The present disclosure pertains to computers and, more particularly, to methods and an apparatus for securely configuring a machine in a pre-operating system environment.

### BACKGROUND

Updating a computer's pre-operating system configuration (e.g., a firmware setting, a basic input/output system (BIOS) setting, a platform setting, etc.) has typically been a manual process. Individual users (e.g., an individual who maintains and/or owns a computer for home, business and/or personal use) and/or administrators of a network of computers (e.g., a local area network (LAN)) are required to identify the need to update the pre-operating system configuration, obtain the update, and apply the update. The update process can be labor intensive in a LAN including a large number of computers, several different types of computer types and/or computer platforms because each computer must be attended to individually. Due to the number of computers and the different types of computers that may be involved, the local administrator is presently forced to update one computer at a time. This update process may also be conducive to user errors in the update process due to the different types of computers in the LAN. The update process may be complicated for an individual user due to the individual's unfamiliarity with the computer's hardware and/or settings.

Methods exist for a third party (e.g., an Original Equipment Manufacturer (OEM), a processor manufacturer, and/or some other hardware manufacturer) to automatically update a computer's pre-operating system configuration. These methods may require exposing a computer's identity or user information (e.g., a computer/hardware serial number, a user's personal information, and/or a registration number) to the third party, trusting the third party to provide non-malignant updates, and compromising user privacy.

### BRIEF DESCRIPTION OF THE DRAWINGS

FIG. 1 is a block diagram of an example client/server system for securely configuring a machine in a pre-operating system environment.

FIG. 2 is a block diagram of a second example client/server system for securely configuring a machine in a pre-operating system environment.

FIG. 3 is a flowchart representative of example machine readable instructions that may be executed by a client to implement the example client system of FIG. 1.

FIG. 4 is a flowchart representative of example machine readable instructions that may be executed by a server to implement the example server system of FIG. 1.

FIG. 5 is a flowchart representative of example machine readable instructions that may be executed by a device to implement the update any managed clients process.

FIG. 6 is a flowchart representative of example machine readable instructions that may be executed by a device to implement the update any consumer clients process.

FIG. 7 is a block diagram of an example computer system that may be used to implement the client and/or server of FIG. 1.

### DETAILED DESCRIPTION

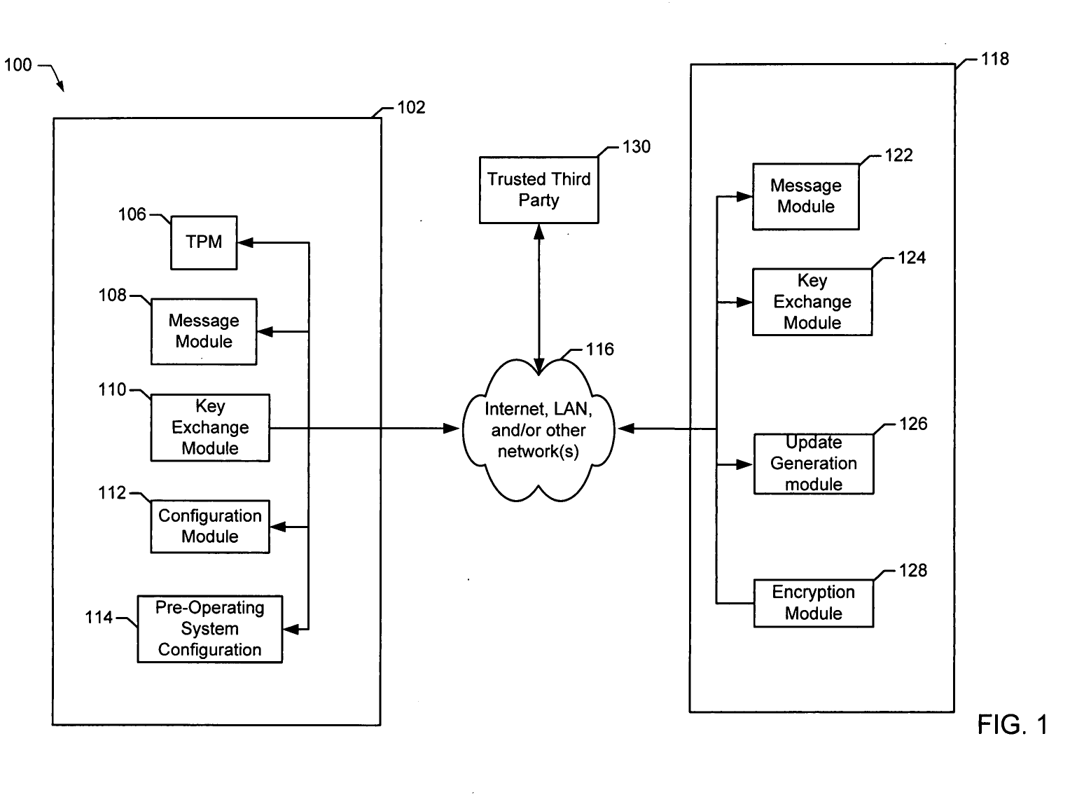

FIG. 1 illustrates an example client/server system for securely configuring a machine in a pre-operating system environment and the individual blocks will be described in detail below. Generally, the server is configured to determine if a configuration update is available for distribution. The server broadcasts a message indicating the availability of the update to various clients (e.g., individual owners and corporate information technology department (IT) managed devices) and requests an attestation from each of the responding clients. Each client's attestation is verified by a Trusted Third Party before a configuration update is transmitted to the client. After the attestation is verified, each client receives the configuration update and applies the update.

FIG. 1 is a block diagram of an example system 100 for securely configuring a machine in a pre-operating system environment. The example system 100 may be implemented as several components of hardware each configured to perform one or more functions, may be implemented in software or firmware where one or more programs are used to perform the different functions, or may be a combination of hardware, firmware, and/or software. In this example, the example system 100 includes a client 102, a network 116, a server 118, and a Trusted Third Party (TTP) 130.

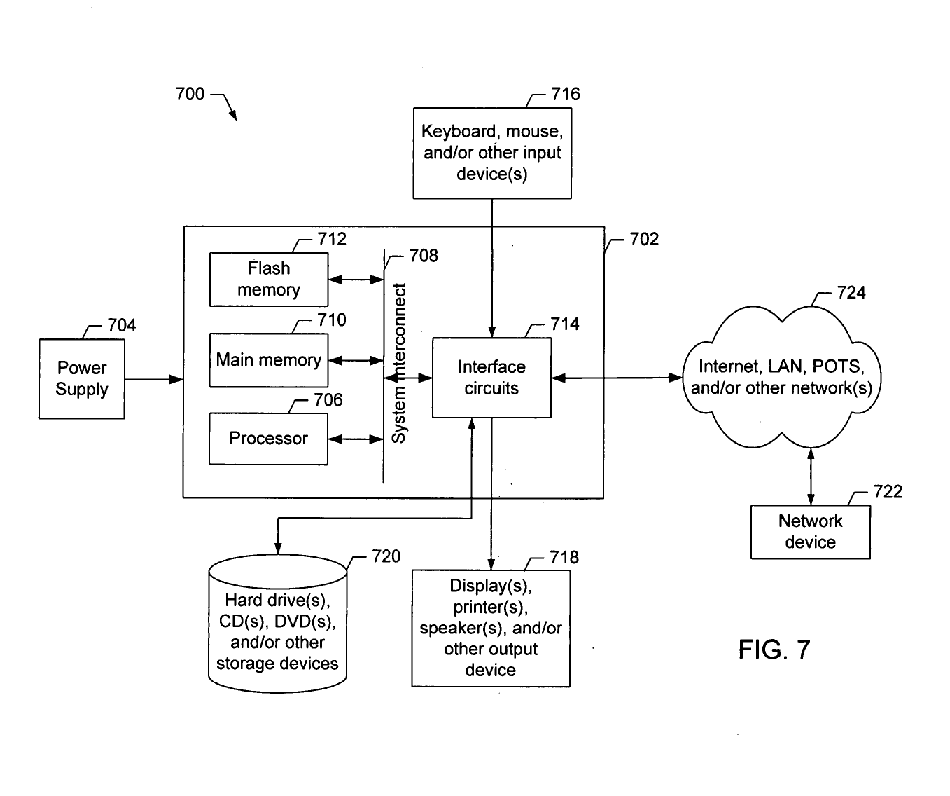

The client 102 may be any type of machine configured to receive configuration updates. Examples include a computer 700 as shown in FIG. 7, a cellular telephone, and/or any processor-based device. The client 102 comprises a trusted platform module (TPM) 106, a message module 108, a key exchange module 110, a configuration module 112, and a pre-operating system configuration 114.

The TPM 106 is configured to provide an attestation to prove the identity of the client 102. The attestation may be a pseudo-anonymous attestation such as an Attestation Identity Key (AIK), which is a cryptographic mechanism that provides a digital signature and is well known to those having ordinary skill in the art. The attestation may also be a conventional attestation such as a serial number and/or a cryptographic representation of a set of registers internal to the TPM (e.g., a set of Platform Configuration Registers (PCR)).

The message modules 108 and 122 are configured to receive and transmit messages to other message modules via a network connection. These messages may be, but are not limited to, management messages (e.g., a series of Universal Datagram Protocol (UDP) transactions known in the art), start messages (e.g., a Hello Message), an end message (e.g., a Goodbye Message), messages targeted at specific port numbers, and/or acknowledgement messages. The messages may be sent by calling an Application Program Interface (API) such as a software function provided in the Extensible Firmware Interface (EFI) API. The messages may be transmitted using a simple network protocol, but a person of ordinary skill in the art will appreciate that the messages may be transmitted via different methods.

The key exchange modules 110 and 124 are configured to allow a client 102 to exchange a common key with a server 118. The key may be a symmetric key used to encrypt and decrypt data. According to one example, the key may be a shared key that is exchanged using a Diffie-Hellman key agreement protocol, which is a protocol well known to those having ordinary skill in the art. Of course, a person of ordinary skill in the art will appreciate that the key exchange is not limited to the Diffie-Hellman key agreement protocol.

The configuration module 112 is configured to update the device's pre-operating system configuration 114. In particular, the configuration module 112 receives a configuration update from a tangible medium such as a CD-ROM, a floppy disk, a hard drive, from the network 116, and/or from a user. The configuration module 112 may also be configured to decrypt the configuration update using the shared key exchanged by the key exchange module 110. The configuration module 112 applies the update to the device pre-operating system configuration 114, which may include, but is not a limited to, a BIOS, firmware, microcode, and/or any other platform setting.

The client 102 is connected to the server 118 via the network 116. The network 116 may be any type of network, such as the Internet, a LAN, a telephone network, a cable network, and/or a wireless network. The client 102 may communicate with the server 118 via any means of network protocol.

The server 118 may be any type of machine configured to transmit configuration updates to the client 102. The server 118 comprises a message module 122, a key exchange module 124, an update generation module 126, and an encryption module 128.

The update generation module 126 of the server 118 is configured to provide the configuration setting updates to be transmitted to the client 102. The update generation module 126 may provide a configuration update that may include, but not limited to, a BIOS setting update, a firmware update, and/or any platform configuration update. The updates may be generated by the update generation module 126 or may be provided to the update generation module 126 by a user or another device.

The encryption module 128 is configured to encrypt the configuration setting update provided by the update generation module 126. The encryption module 128 may use the key exchanged by the key exchange module 124 to encrypt the update using any known encryption algorithm such as the Advanced Encryption Standard (AES). A person of ordinary skill in the art will appreciate there are several methods to implement the encryption module 128 and the encryption algorithm used by the encryption module 128.

The TTP 130 is configured to verify the client's attestation. The TTP 130 may be connected to the server 118 by the network 116 and communicates with the server 118 using any network protocol. One example TTP 130 is Verisign, Inc., a company providing trust services and digital certificate services. The server 118 receives the client's attestation and queries the TTP 130 to verify the authenticity of the attestation. The TTP 130 may access an attestation database to verify the client's authenticity and communicates the status of the authenticity of the client's attestation to the server 118. The TTP 130 is well known in the art, and therefore is not further described.

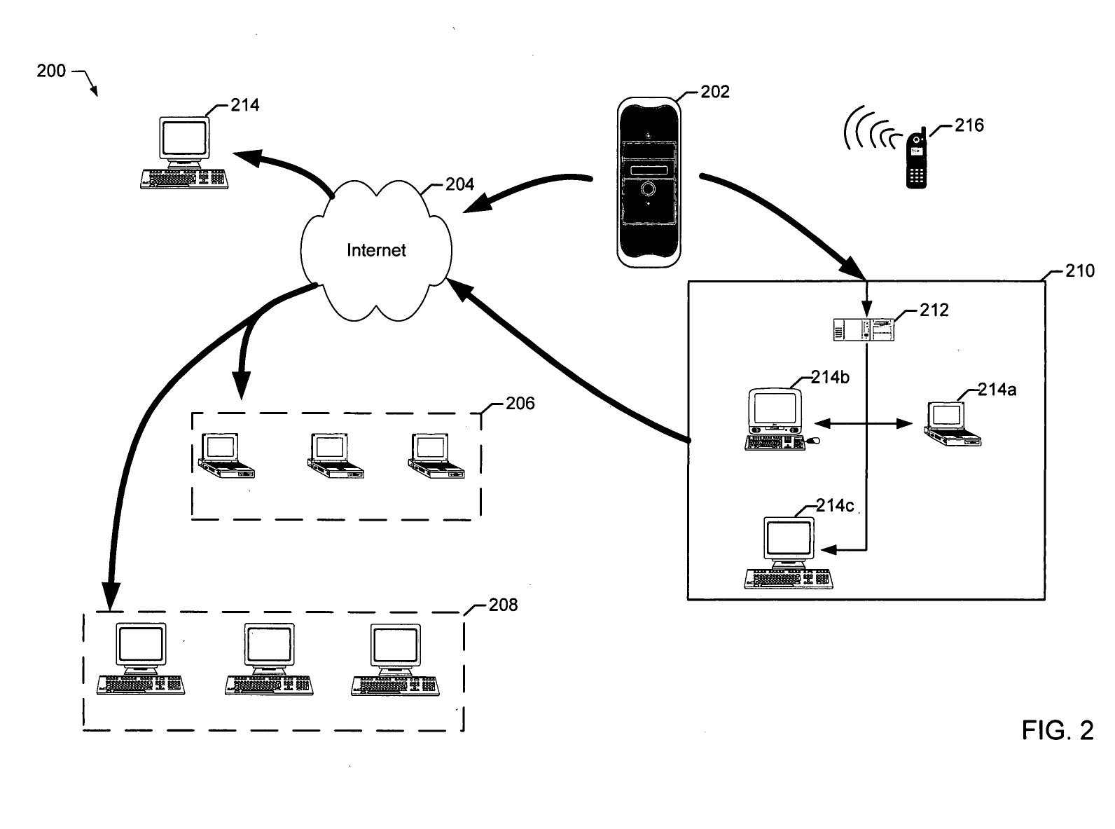

FIG. 2 illustrates an example client/server system 200 is a second example client/server system for securely configuring a machine in a pre-operating system environment. A server 202 is connected to the Internet 204 and is connected to a corporate network 210 (e.g., an Intel internal network). A first client type 206 (e.g., a set of laptop computers having a specific configuration and/or hardware) is connected to the server 202 via the Internet 204. A second client type 208 (e.g., a set of desktop computers having a specific configuration and/or hardware) is also connected to the server 202 via the Internet 208. The first client type 206 and the second client type 208 are both configured to receive configuration updates from the server 202 via the Internet 204.

The server 202 is able to query a TTP 214. The server 202 is connected to the TTP 214 via a network connection, such as the Internet 204. The first client type's attestation and the second client type's attestation are received by the server 202, which verifies the authenticity of the attestations by querying the TTP 214.

The server 202 is also connected to the corporate network 210 and may transfer configuration updates to a central computer 212 in the corporate network 210. The central computer 212 may then act as a server within the corporate network 210 and request the attestation from the clients in the corporate network 214a-c. After the clients 214a-c have been verified, the central computer 212 distributes the configuration update to each client.

The server 202 is also able to connect to a portable device enabled to receive configuration updates. In the example system of FIG. 2, the portable device is a cellular phone 216 that is able to connect with the server 202, provide an attestation there to, and receive configuration updates. The cellular phone 216 may connect via a wireless method or through a wired connection such as a cradle/hub system (not shown). The cellular phone 216 provides an attestation to the server 202 and the attestation is verified by the TTP 214 before any configuration updates are sent to the celluluar phone 216.

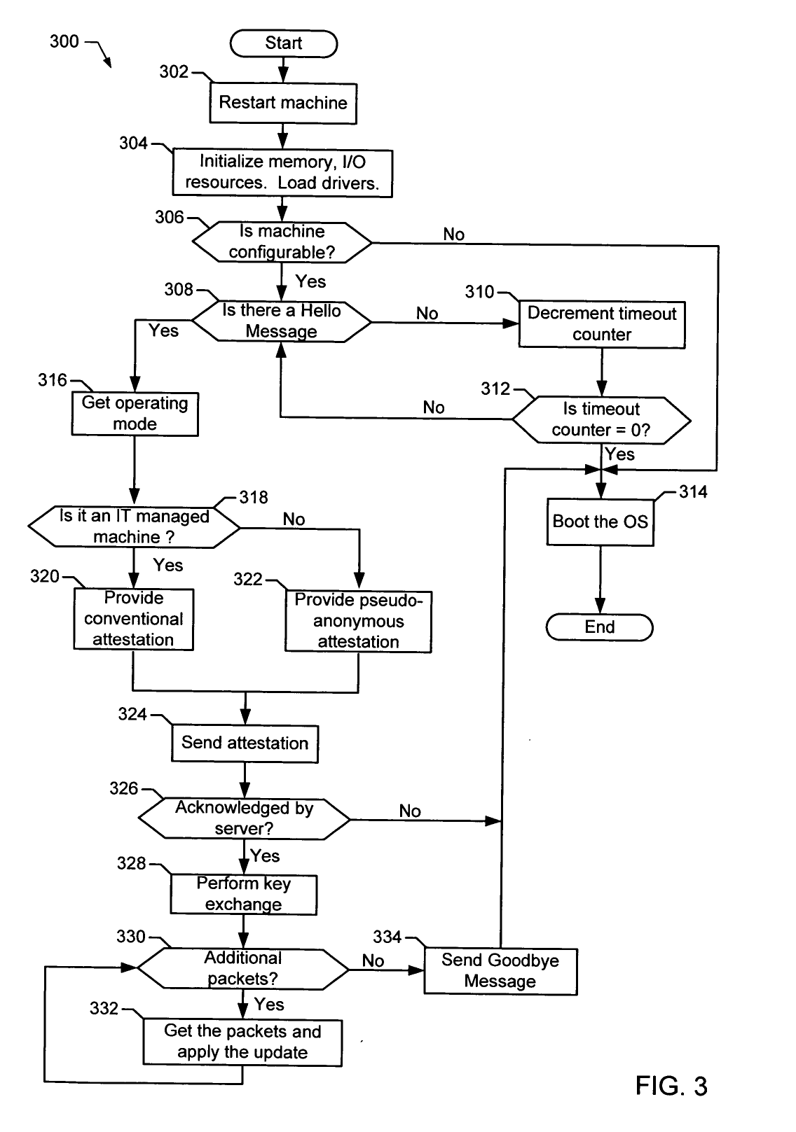

FIGS. 3, 4, 5, and 6 are flowcharts representative of example machine readable instructions that may be executed by a device to implement an example method of securely configuring a machine in a pre-operating system environment. Preferably, the illustrated processes 300, 400, 450, and 500 are embodied in one or more software programs that are stored in one or more memories (e.g., flash memory 712 and/or hard disk 720) and executed by one or more processors (e.g., processor 706) in a well known manner. For example, any or all of the message modules 108 and 122, the key exchange modules 110 and 124, configuration module 112, the pre-operating system configuration 114, the update generation module 126, and the encryption module 128 could be implemented by software, hardware, and/or firmware. Further, although the example program is described with reference to the flowcharts illustrated in FIGS. 3, 4, 5, and 6, persons of ordinary skill in the art will readily appreciate that many other methods of implementing the example system 100 may alternatively be used. For example, the order of execution of the blocks may be changed, and/or some of the blocks described may be changed, eliminated, or combined.

In general, the example process 300 updates a configuration setting in a client 102 in a pre-operating system environment (e.g., a stage in the client's start process in which the operating system has not been initialized and/or started). The client 102 is restarted and waits for a message from a server 118 indicating there is a configuration update. If the client 102 receives the server's message, the client 102 provides an attestation to the server 118. The server 118 verifies the client's attestation and transmits the configuration setting update to the client 102. After the client 102 receives the update, the pre-operating system configuration 114 is updated.

In particular, the example process 300 begins by restarting the client 102 (block 302) and initializing different components of the client 102 (block 304). Example components that may be initialized are the main memory 710 of FIG. 7, input and output interfaces (I/O), network interfaces, and/or various firmware drivers. After the components have been initialized (block 304), the client 102 determines if it is able to receive configuration updates (e.g., is the client 102 opted-in) by querying the TPM 106 (block 306). A client 102 may be opted-in by a user setting or some other method. If the client 102 is not opted-in, the client 102 continues by booting the operating system (block 314).

If the client 102 is opted-in, the client's message module 108 determines if a Hello Message has been received (block 308). The client's message module 108 may determine if the Hello Message has been received by examining a Network Interface Card (NIC) or some other network interface. The Hello Message may be a User Datagram Protocol (UDP) message formatted to a particular network port or a particular network packet sent to a particular port with a special format to indicate that the packet is the Hello Message. If the Hello Message is not detected, a timeout counter is decremented (block 310) and the timeout counter is compared to zero (e.g., timeout counter=0) (block 312). If the timeout counter is not equal to zero, control returns to block 308 to determine if a Hello Message has been received. If the timeout counter is equal to zero, the client 102 boots the operating system (block 314).

If the Hello Message is detected (block 308), the client's message module 108 may send an acknowledgement message or some other indication that the Hello Message was received. The client 102 then determines its operating mode (block 316). The operating mode may be, but is not limited to, a managed client (e.g., a corporate IT managed machine) and/or an independent client (e.g., a consumer machine). If the client 102 is a managed client (block 318), the TPM 106 provides a conventional attestation (block 320). The conventional attestation may include the client's serial number, a TPM_Quote (e.g., a cryptographic reporting of PCR values), and/or a client's network name. If the client 102 is not a managed client (block 318), the TPM 106 provides a pseudo-anonymous attestation (block 322). The pseudo-anonymous attestation provides a method to securely identify a client 102 without revealing the client's identity and/or a user's personal information (e.g., the pseudo-anonymous attestation provides information proving that the client 102 is a valid platform, but does not provide information identifying the machine). The pseudo-anonymous attestation may include, for example, an AIK.

The client 102 transmits the attestation, either the conventional or the pseudo-anonymous attestation, to the server 118 (block 324) and waits for the server 118 to acknowledge the attestation (e.g., to verify the authenticity of the attestation). If the attestation is not acknowledged, the client 102 boots the operating system (block 314). Alternatively, if the attestation is acknowledged, the client's key exchange module 110 performs a key exchange with the server 118 (block 328). In one example, the key exchange may be a symmetric key exchange similar to the Diffie-Hellman key exchange.

After the key exchange (block 328), the client 102 determines if there are any update packets to be received (block 330). This may be implemented by polling the receive buffer of the NIC until the buffer is empty and no additional packets are received. If there is an update packet, the client 102 retrieves the packet and applies the configuration request enclosed in the packet (block 332). Control then returns to block 330 to determine if additional packets are received.

If there are no additional packets, the client's message module 108 transmits a Goodbye Message to the server (block 334). The Goodbye Message may have a similar format as the Hello Message described above. After the Goodbye Message has been transmitted, the client 102 boots the operating system (block 314).

Turning now to the server-side operation, in general, the example process 400 transmits a configuration update to a client 102 in a pre-operating system environment. The server 118 is restarted and determines if there is an update to transmit to the clients 102. If there is an update to be transmitted, the server 118 updates the managed clients and then updates the independent clients.

The example process 400 begins by restarting the server 118 (block 402). The server 118 then determines if there are configuration updates in the update generation module 126 to transmit (block 404). If there are no configuration updates to transmit, the server 118 waits for a configuration update to become available (block 406).

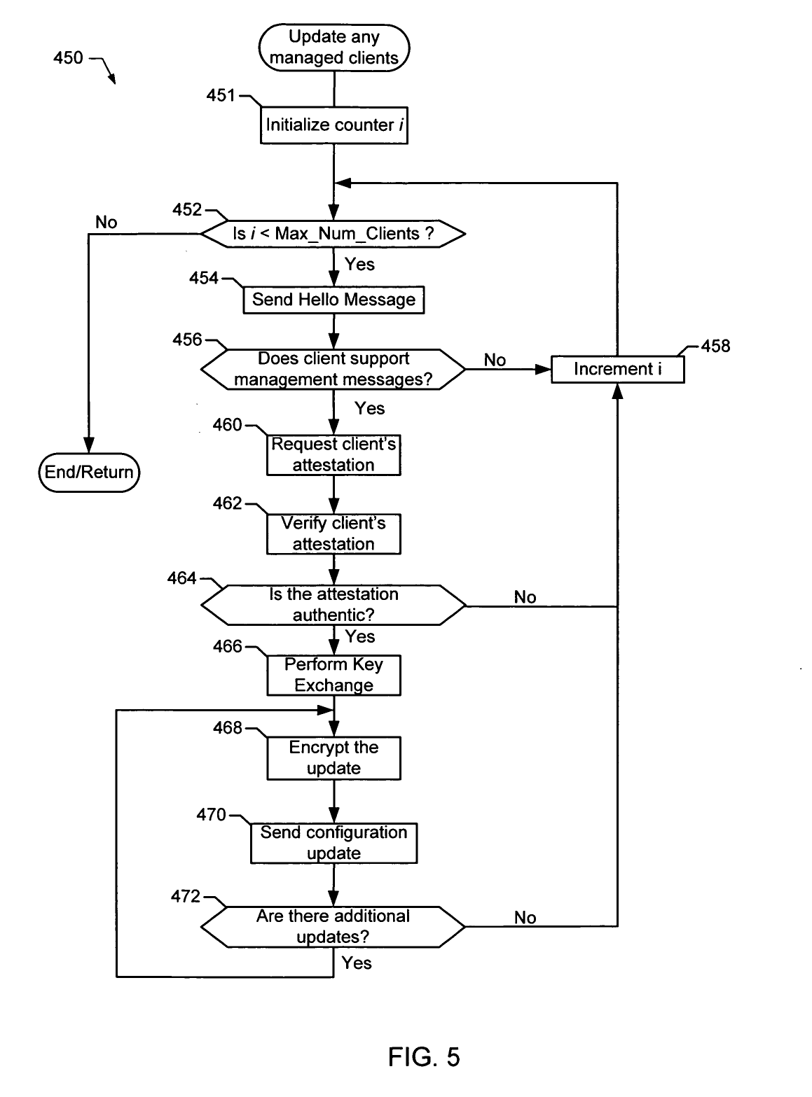

If the update generation module 126 contains a configuration update to be transmitted, the server 118 attempts to transmit the configuration update to the managed clients (e.g., corporate IT managed computers) (block 450). Process 450 of FIG. 5 is a flowchart representative of instructions that may be executed by the server 118 to transmit the configuration update to the managed clients.

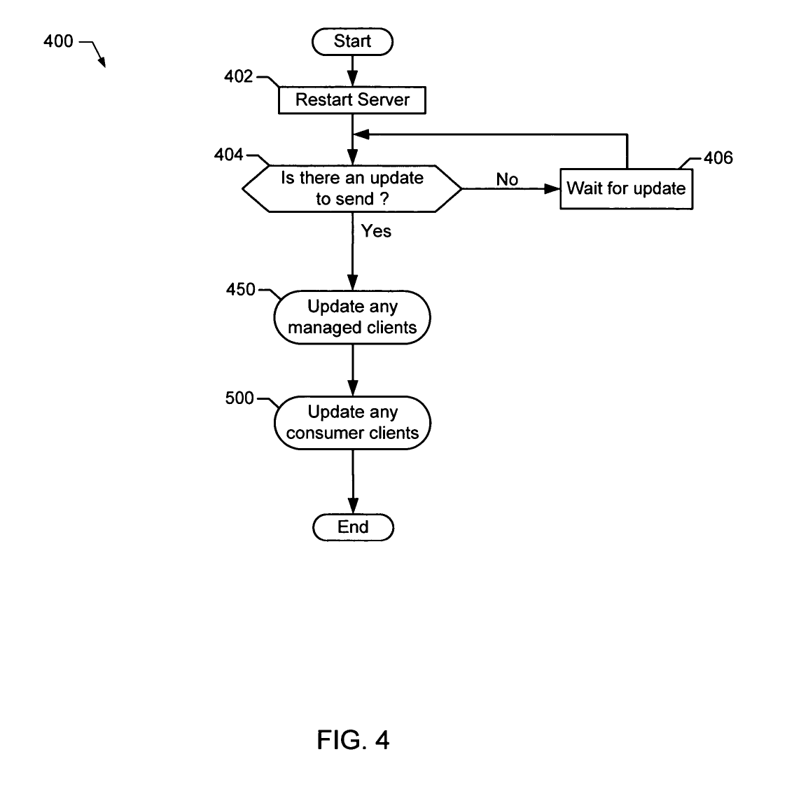

As shown in FIG. 5, the update any managed client process 450 begins by the server 118 first initializing a counter i to be equal to zero (e.g., i=0) (block 451). The server 118 then determines if counter i is less than the number of clients (e.g., i<MAX_NUM_CLIENTS) (block 452). If counter i is not less than the number of clients, control returns to block 500 of FIG. 4. Alternatively, if counter i is less than the number of clients, the server's message module 122 transmits a Hello Message to the first managed client remaining to be updated (block 454).

The server 118 determines if the managed client supports management messages (block 454). The server 118 may determine if the managed client supports management messages by determining if the managed client acknowledges the Hello Message. If the managed client does not support management messages, the counter i is incremented and control returns to block 452 and the next client is processed. If the managed client supports management messages, the server's message module 122 sends the managed client a message requesting the managed client's attestation (block 460). The attestation request may be implemented by using a TPM command, such as a TPM_Quote command. The server 118 receives the attestation from the managed client and attempts to verify the authenticity of the attestation (block 462). The server 118 may query the TTP 130 to determine the authenticity of the client's attestation.

If the TTP 130 determines the attestation is not authentic (block 464), the server 118 increments the counter i and control returns to block 452 to attempt to update the next client. If the attestation is authentic, the key exchange module 124 performs a symmetric key exchange with the managed client (block 466). The symmetric key exchange may be implemented with the Diffie-Hellman key exchange or a similar key exchange protocol.

The encryption module 128 then encrypts the configuration update using the key exchanged in block 466 (block 468). The encryption module 128 uses the key generated in the symmetric key exchange to encrypt the configuration update. After the update is encrypted (block 468), the server 118 transmits the configuration update to the managed client (block 470). The server 118 determines if there are additional configuration updates to transmit (block 472). The server 118 may determine if there are additional configuration updates by querying the update generation module 126. If there are additional configuration updates, control returns to block 468. If there are no additional configuration updates to transmit, control returns to block 458.

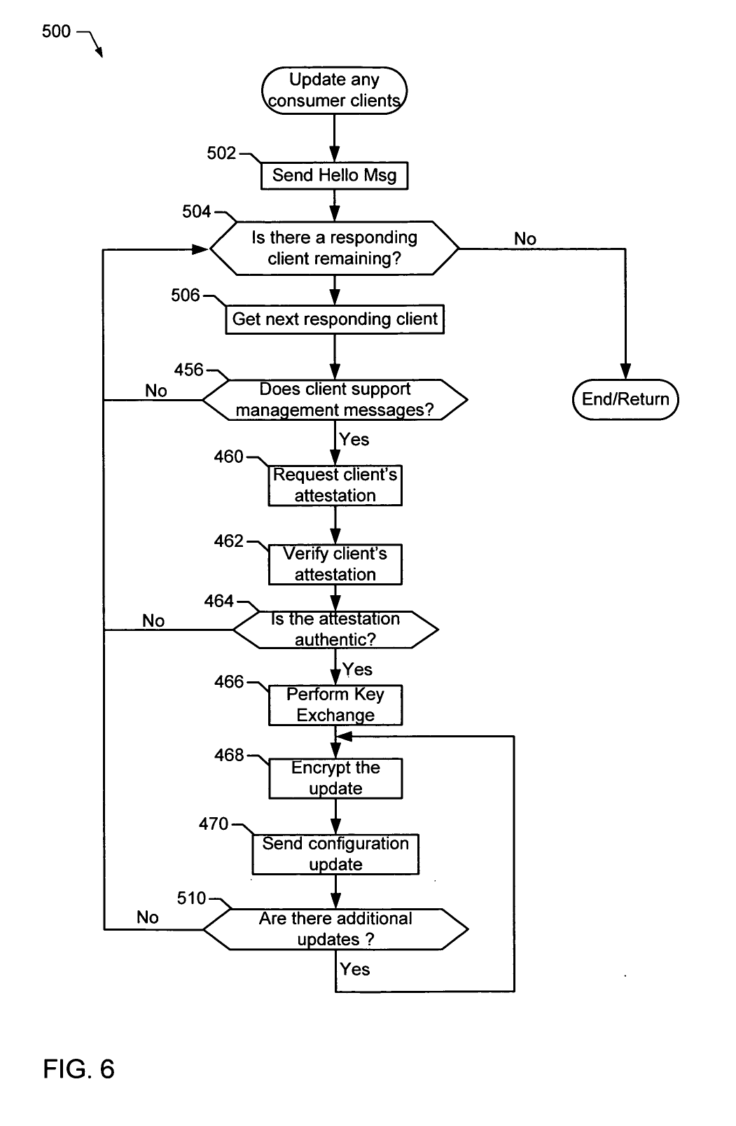

Returning briefly to FIG. 4, after the managed clients are updated (block 450), the server 118 updates independent clients (block 500). Process 500 of FIG. 6 is a flowchart representative of instructions that may be executed by the server 118 to transmit the configuration update to the independent clients (e.g., consumer computers).

The server's message module 122 transmits the Hello Message (block 502) as described in block 454 of FIG. 5. The server 118 determines if any clients responded to the Hello Message and may create a list to manage the responding clients. The server determines if there are clients in the list who have responded to the Hello Message that have not been yet updated (block 504). If there are no remaining clients to be updated, control returns to process 400. If there are independent clients remaining to be updated, the server 118 retrieves the first remaining client to be updated (block 506). Blocks 456, 458, 460, 462, 464, 466, 468, and 470 of FIG. 6 are identical to the like numbered blocks of FIG. 5 and will not be described here. The server determines if there are additional updates to transmit (block 510). If there are additional updates to transmit, control returns to block 468. Otherwise, control returns to block 504.

A person of ordinary skill in the art will readily appreciate the fact that the methods and apparatus disclosed above are not limited to a pre-operating system environment. The methods may be extended to an operating system-transparent (OS-transparent) operating mode that has networking support. An OS-transparent operating mode comprises execution of firmware independently of the operating system. An example may be power management software that monitors a battery power level in a laptop computer and engages the power down process when a low battery level is detected. The methods described above may be extended to securely update the pre-operating system configuration while in this OS-transparent operating mode.

FIG. 7 is a block diagram of an example computer system illustrating an environment of use for the disclosed system. The computer system 700 may be a personal computer (PC) or any other computing device. In the example illustrated, the computer system 700 includes a main processing unit 702 powered by a power supply 704. The main processing unit 702 may include a processor 706 electrically coupled by a system interconnect 708 to a main memory device 710, a flash memory device 712, and one or more interface circuits 714. In an example, the system interconnect 708 is an address/data bus. Of course, a person of ordinary skill in the art will readily appreciate that interconnects other than busses may be used to connect the processor 706 to the other devices 710, 712, and 714. For example, one or more dedicated lines and/or a crossbar may be used to connect the processor 706 to the other devices 710, 712, and 714.

The processor 706 may be any type of well known processor, such as a processor from the Intel Pentium® family of microprocessors, the Intel Itanium® family of microprocessors, the Intel Centrino® family of microprocessors, and/or the Intel XScale® family of microprocessors. In addition, the processor 706 may include any type of well known cache memory, such as static random access memory (SRAM). The main memory device 710 may include dynamic random access memory (DRAM) and/or any other form of random access memory. For example, the main memory device 710 may include double data rate random access memory (DDRAM). The main memory device 710 may also include non-volatile memory. In an example, the main memory device 710 stores a software program which is executed by the processor 706 in a well known manner. The flash memory device 712 may be any type of flash memory device. The flash memory device 712 may store firmware used to boot the computer system 700.

The interface circuit(s) 714 may be implemented using any type of well known interface standard, such as an Ethernet interface and/or a Universal Serial Bus (USB) interface. One or more input devices 716 may be connected to the interface circuits 714 for entering data and commands into the main processing unit 702. For example, an input device 716 may be a keyboard, mouse, touch screen, track pad, track ball, isopoint, and/or a voice recognition system.

One or more displays, printers, speakers, and/or other output devices 718 may also be connected to the main processing unit 702 via one or more of the interface circuits 714. The display 718 may be a cathode ray tube (CRT), a liquid crystal displays (LCD), or any other type of display. The display 718 may generate visual indications of data generated during operation of the main processing unit 702. The visual indications may include prompts for human operator input, calculated values, detected data, etc.

The computer system 700 may also include one or more storage devices 720. For example, the computer system 700 may include one or more hard drives, a compact disk (CD) drive, a digital versatile disk drive (DVD), and/or other computer media input/output (I/O) devices. In addition to the text strings stored in the flash memory device 712 (if any), one or more storage devices 720 (e.g., a hard disk) may store text strings in one or more languages.

The computer system 700 may also exchange data with other devices 722 via a connection to a network 724. The network connection may be any type of network connection, such as an Ethernet connection, digital subscriber line (DSL), telephone line, coaxial cable, etc. The network 724 may be any type of network, such as the Internet, a telephone network, a cable network, and/or a wireless network. The network devices 722 may be any type of network devices 722. For example, the network device 722 may be a client, a server, a hard drive, etc.

Although the above discloses example systems including, among other components, software executed on hardware, it should be noted that such systems are merely illustrative and should not be considered as limiting. For example, it is contemplated that any or all of the disclosed hardware and software components could be embodied exclusively in dedicated hardware, exclusively in software, exclusively in firmware or in some combination of hardware, firmware and/or software.

In addition, persons of ordinary skill in the art will appreciate that, although certain methods, apparatus, and articles of manufacture have been described herein, the scope of coverage of this patent is not limited thereto. On the contrary, this patent covers all apparatuses, methods and articles of manufacture fairly falling within the scope of the appended claims either literally or under the doctrine of equivalents.

1. A method of securely configuring a first machine in a pre-operating system environment, the method comprising:
detecting a message;
determining an operating mode of the machine;
providing an attestation;
performing a shared secret key exchange;
receiving a configuration update; and
updating a machine configuration in a pre-operating system environment.

2. A method as defined in claim 1, wherein the message is sent from a second machine.

3. A method as defined in claim 1, wherein the operating mode of the first machine comprises at least one of an IT-managed machine and a consumer machine.

4. A method as defined in claim 1, wherein the attestation comprises at least one of machine identity information and a pseudo-anonymous authentication.

5. A method as defined in claim 4, wherein the pseudo-anonymous authentication is provided by a trusted platform module.

6. A method as defined in claim 4, wherein the machine identity information comprises at least one of a serial number, a network name, and a cryptographic representation of hardware registers.

7. A method as defined in claim 4, wherein the pseudo-anonymous authentication comprises an Attestation Identity Key.

8. A method as defined in claim 1, wherein updating the machine configuration in a pre-operating system environment is adapted to operate in an OS-transparent operating mode with networking support.

9. A method of securely configuring a client operating in a pre-operating system environment, the method comprising:
sending a message;
determining an operating mode of the client machine;
receiving an attestation;
verifying the attestation;
performing a shared secret key exchange; and
sending a configuration update to the client machine in a pre-operating system environment.

10. A method as defined in claim 9, wherein the message is to a client machine.

11. A method as defined in claim 9, wherein the operating mode of the client machine comprises at least one of an IT-managed device and a personal device.

12. A method as defined in claim 9, wherein the attestation comprises at least one of client machine identity information and a pseudo-anonymous authentication.

13. A method as defined in claim 12, wherein the client machine identity information comprises at least one of a serial number, a network name, and a cryptographic representation of hardware registers.

14. A method as defined in claim 12, wherein the pseudo-anonymous authentication comprises an Attestation Identity Key.

15. A method as defined in claim 9, wherein the attestation is verified by a trusted third party.

16. A method as defined in claim 9, wherein the configuration comprises at least one of a firmware setting, a BIOS setting, and a machine setting.

17. A method as defined in claim 16, wherein the configuration update comprises an encrypted configuration update.

18. A method as defined in claim 9, wherein sending the configuration update to the client machine in a pre-operating system environment is adapted to operate in an OS-transparent operating mode with networking support.

19. An apparatus to securely configure a client machine in a pre-operating system environment, the apparatus comprising:
a client machine comprising:
a messaging module configured to detect messages and send messages;
an operating mode;
a trusted platform module configured to provide an attestation;
a key exchange module configured to perform a shared secret key exchange; and
a configuration module configured to update the client's configuration in a pre-operating system environment; and
a server machine comprising:
an messaging module configured to send messages and receive messages;
a key exchange module configured to perform a shared secret key exchange after an attestation has been verified; and
an update module configured to generate a client configuration update.

20. An apparatus as defined in claim 19, wherein the client machine's operating mode comprises at least one of an IT-managed machine and a consumer machine.

21. An apparatus as defined in claim 19, wherein the trusted platform module is configured to use at least one of a pseudo-anonymous authentication and machine identity information.

22. An apparatus as defined in claim 19, wherein the configuration module is configured to update at least one of a firmware setting, a BIOS setting, and a machine setting.

23. An apparatus as defined in claim 19, wherein the configuration module is adapted to update the client's configuration in an OS-transparent operating mode with networking support.

24. An apparatus as defined in claim 19, wherein the update module is configured to generate at least one of a firmware update, a BIOS update, and a machine setting update.

25. An apparatus as defined in claim 19, wherein the server machine further comprises an encryption module configured to encrypt the client configuration update.

26. A machine readable medium having instructions stored thereon that, when executed, cause a machine to:
detect a message;
determine an operating mode of the machine;
provide an attestation;
perform a shared secret key exchange;
receive a configuration update; and
update a machine configuration in a pre-operating system environment.

27. A machine readable medium as defined in claim 26, having instructions stored thereon that, when executed, cause the machine to receive the message from a server.

28. A machine readable medium as defined in claim 26, having instructions stored thereon that, when executed, cause the machine to update at least one of a firmware setting, a BIOS setting, and a machine setting.

29. A machine readable medium having instructions stored thereon that, when executed, cause a first machine to:
send a message;
determine an operating mode of a second;
receive an attestation;
verify the attestation;
perform a shared secret key exchange; and
send a configuration update to the client machine in a pre-operating system environment.

30. A machine readable medium as defined in claim 29, having instructions stored thereon that, when executed, cause the first machine to send the message via a network connection.

31. A machine readable medium as defined in claim 29, having instructions stored thereon that, when executed, cause the first machine to query a trusted third party to verify the attestation.

32. A machine readable medium as defined in claim 29, having instructions stored thereon that, when executed, cause the first machine to encrypt the configuration update.
